(19) United States
(12) Patent Application Publication
(10) Pub. No.: US 2018/0334143 A1
(43) Pub. Date: Nov. 22, 2018

(54) SNOW PLOW SYSTEM AND METHOD

(71) Applicant: Steve Cummings, Norway, ME (US)

(72) Inventor: Steve Cummings, Norway, ME (US)

(21) Appl. No.: 15/986,761

(22) Filed: May 22, 2018

Related U.S. Application Data
(60) Provisional application No. 62/509,723, filed on May 22, 2017.

(51) Int. Cl. B60S 3/04; B08B 1/00

(52) U.S. Cl. CPC B60S 3/04; B08B 1/005

(57) ABSTRACT

A snow plow system which includes a frame, a snow plow, a chain hoist, and a removably attached stair case. The snow plow system is useful for the removal of snow from a vehicle's roof when the vehicle passes through the frame. The chain hoist may provide vertical adjustments to the snow plow to accommodate a variety of vehicle heights.

### CROSS-REFERENCE TO RELATED APPLICATION(S)

The present application is related to and claims priority to U.S. Provisional Patent Application No. 62/509,723 filed May, 22, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of snow removal of existing art and more specifically relates to snow removal from a roof of a vehicle.

### RELATED ART

During winter months, it is not uncommon for snow to accumulate on a vehicle's roof. Cleaning snow off a vehicle, such as a tractor trailer or box truck, is of paramount importance. Often drivers are forced to climb up the vehicle or truck and manually clean off the snow resulting in potential injury or worse. However, if the snow is not removed, serious accidents and injuries can occur to other drivers if the snow and debris fly off while the vehicle is moving. Additionally, drivers can be fined if the snow is not cleared off. Therefore, a suitable solution is required.

U.S. Pat. No. 5,802,654 to William E. Yeaglin relates to a snow and ice remover for vehicle roofs. The described snow and ice remover for vehicle roofs includes a snow and ice remover for the roofs of trucks and trailers. A bridge-like structure of two vertical beams and an upper cross piece supports a vertically adjustable snow plow assembly which rolls on wheels riding on the vertical beams. A wedge-shaped plow forms the lower edge of the snow plow assembly so that when a snow or ice covered truck or trailer moves under the properly positioned plow, the snow or ice is pushed off the top of the vehicle. The snow plow has a minimum height below which it cannot be lowered, and the adjustment of the snow plow is powered by a winch on the cross beam which reels in or releases a chain from which the snow plow is hung.

### SUMMARY OF THE INVENTION

In view of the foregoing disadvantages inherent in the known snow removal art, the present disclosure provides a novel snow plow system and method. The general purpose of the present disclosure, which will be described subsequently in greater detail, is to provide an efficient and effective snow plow system for the removal of snow from a roof of a movable vehicle.

A snow plow system is disclosed herein. The snow plow system includes a frame having two vertical support beams connected via an upper horizontal crossbar, and a first pair of stabilizers each attached between the two vertical support beams and a ground surface. The snow plow system may further include a snow plow connected to the frame below the upper horizontal crossbar and movable along the two vertical support beams, a chain hoist coupled to the upper horizontal crossbar at one end and to the snow plow at an opposing end, and a stair case removably attachable to the frame. The stair case includes a series of steps. The vehicle may be configured to pass between the two vertical support beams. The snow plow may be vertically adjustable to a height associated to the roof of the vehicle to enable removal of snow therefrom when the vehicle passes though the two vertical support beams.

According to another embodiment, a method of using a snow plow system is also disclosed herein. The method of using the snow plow system includes a providing a snow plow system as described above, adjusting a height of the snow plow to accommodate to a height associated to a roof of a vehicle, and passing the vehicle through the two vertical support beams enabling the snow plow to remove snow from the roof of the vehicle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a snow plow system and method, constructed and operative according to the teachings of the present disclosure.

FIG. 1 is a perspective view of the snow plow system during an ‘in-use’ condition, according to an embodiment of the disclosure.

FIG. 2 is a perspective view of the snow plow system of FIG. 1, according to an embodiment of the present disclosure.

FIG. 3 is a perspective view of the snow plow system of FIG. 1, according to an embodiment of the present disclosure.

FIG. 4 is a perspective side view of the snow plow system of FIG. 1, according to an embodiment of the present disclosure.

FIG. 5 is a flow diagram illustrating a method of using the snow plow system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to snow removal means and more particularly to a snow plow system and method as used to improve the removal of snow from a roof of a vehicle.

Generally, the present invention provides users with a snow plow system for a vehicle, such as tractor trailers and box trucks. The snow plow system may enable the removal of snow from the roof of the vehicle before operation. It virtually eliminates the need to manually clear snow off the vehicle's roof, allowing the user to operate the vehicle quickly after a snow storm. The snow plow system further prevents snow from flying off the vehicle on a highway and causing accidents for other motorists. The present invention improves travel times for vehicles like tractor trailers and box trucks, ensuring the vehicle can get on the road quickly during winter months.

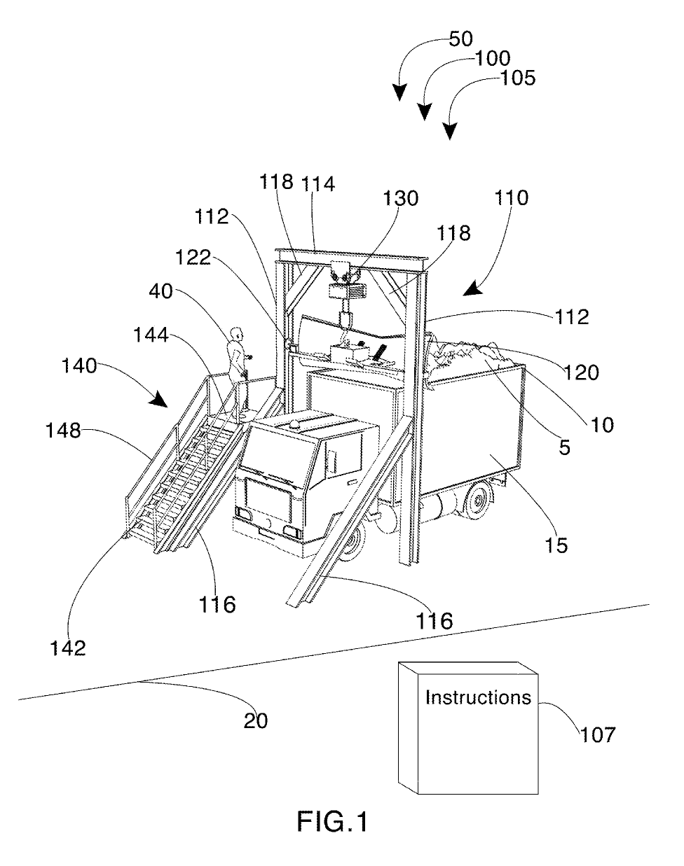

Referring now more specifically to the drawings by numerals of reference, there is shown in FIGS. 1-4, various views of a snow plow system 100.

FIG. 1 shows a snow plow system 100 during an ‘in-use’ condition 50, according to an embodiment of the present disclosure. Here, the snow plow system 100 may be beneficial for use by a user 40 to remove snow 5 accumulated on a roof 10 of a vehicle 15. As illustrated, the snow plow system 100 may include a frame 110 having two vertical support beams 112 connected via an upper horizontal crossbar 114, and a first pair of stabilizers 116 each attached between the two vertical support beams 112 and a ground surface 20. The frame 110 further includes the second pair of stabilizers 118 attached between the two vertical support beams 112 and the upper horizontal crossbar 114 to prevent distortion of the frame 110. A snow plow 120 may be connected to the frame 110 below the upper horizontal crossbar 114 and movable along the two vertical support beams 112. A chain hoist 130 coupled to the upper horizontal crossbar 114 at one end and to the snow plow 120 at an opposing end may enable the snow plow 120 to be movable along the two vertical support beams 112. The snow plow 120 system may further include a stair case 140 removably attachable to the frame 110. The stair case 140 includes a series of steps 142.

The vehicle 15 may be configured to pass between the two vertical support beams 112. The snow plow 120 is vertically adjustable to a height associated to the roof 10 of the vehicle 15 to enable removal of the snow 5 therefrom when the vehicle 15 passes though the two vertical support beams 112.

In one embodiment, the chain hoist 130 is manually operable. The stair case 140 may include a height for assisting in manual operation of the chain hoist 130. Further, the stair case 140 may be utilized by the user 40 to assist in guiding the vehicle 15 through the frame 110.

According to one embodiment, the snow plow system 100 may be arranged as a kit 105. In particular, the snow plow system 100 may further include a set of instructions 107. The instructions 107 may detail functional relationships in relation to the structure of the snow plow system 100 such that the snow plow system 100 can be used, maintained, or the like, in a preferred manner.

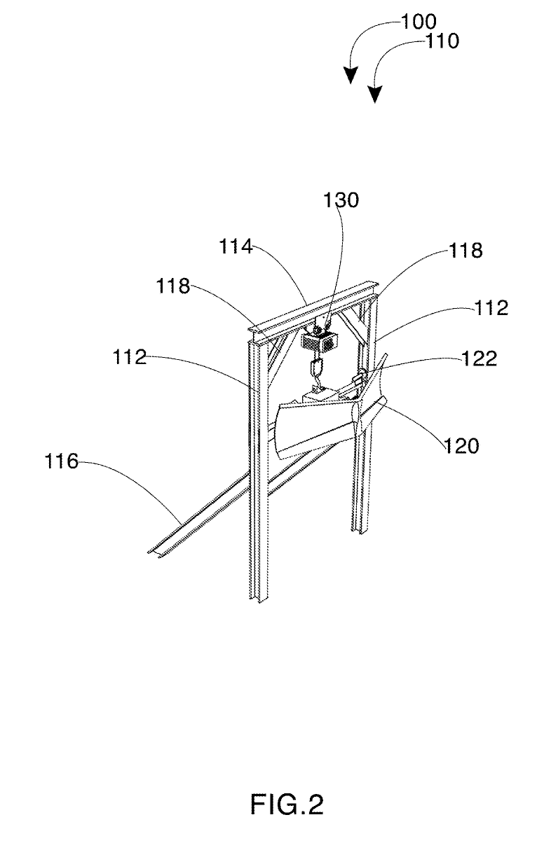

Referring now to FIG. 2 showing the snow plow system 100 of FIG. 1, according to an embodiment of the present disclosure. As above, the snow plow system 100 may include the frame 110 having the two vertical support beams 112 connected via the upper horizontal crossbar 114, and the first pair of stabilizers 116 each attached between the two vertical support beams 112 and the ground surface 20. The frame 110 further includes the second pair of stabilizers 118 attached between the two vertical support beams 112 and the upper horizontal crossbar 114 to prevent distortion of the frame 110. The snow plow 120 may be connected to the frame 110 below the upper horizontal crossbar 114 and movable along the two vertical support beams 112. The chain hoist 130 coupled to the upper horizontal crossbar 114 at one end and to the snow plow 120 at the opposing end may enable the snow plow 120 to be movable along the two vertical support beams 112. The chain hoist 130 may be positioned in a middle of the upper horizontal crossbar 114 such that the snow plow 120 is easily guided when vertically adjusted.

In another embodiment, the chain hoist 130 may be electrically operable. A remote control (not shown) is in electrical communication with the chain hoist 130 to provide vertical adjustments to the snow plow 120, as desired. Controls provided on the remote control may include on/off, vertical adjustments in the upward or downward direction, etc. The remote control may optionally be in wired communication to the chain hoist 130.

The two vertical support beams 112 may include an I-shaped cross-section, known as an I-beam or H-beam. An idler-bearing 122 may be positioned within the two vertical support beams 112 (of the I-shaped cross-section) and configured to guide the snow plow 120 along a length of the two vertical support beams 112. The idler-bearing 122 may attach to both sides of the snow plow 120. The idler-bearing 122 may rotate along the two vertical support beams 112 when the chain hoist 130 in being operated.

Fasteners (i.e., bolts, screws, or the like) may be included for connecting the two vertical support beams 112 to the upper horizontal crossbar 114, and the first pair of stabilizers 116 to the two vertical support beams 112, such that the frame 110 is assembled.

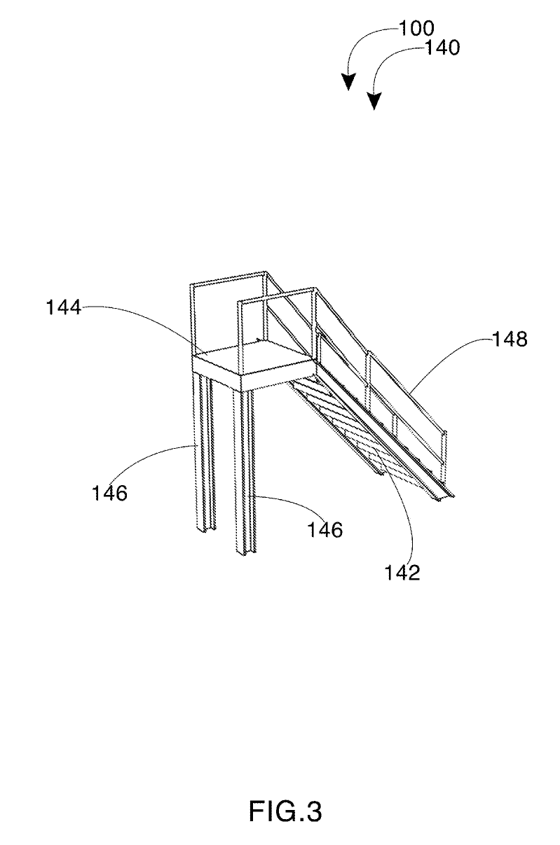

FIG. 3 is a perspective view of the snow plow system 100 of FIG. 1, according to an embodiment of the present disclosure. The snow plow system 100 may include the stair case 140 having the series of steps 142 and is removably attachable to the frame 110. In particular, the stair case 140 may be removably attached to one of the first pair of stabilizers 116 via fasteners (i.e., bolts, screws, or the like).

The stair case 140 may include a platform 144 at a top of the series of steps 142 configured to support a weight of the user 40. The user 40 may assist in guiding the vehicle 15 through the two vertical support beams 112 from the platform 144. The platform 144 may be supported by at least one vertical-stair-beam 146.

The stair case 140 further includes at least one hand-rail 148 positioned and attached along the series of steps 142 and the platform 144. The hand-rail 148 may prevent injury to the user 40 and assist the user 40 in ascending and descending the series of steps 142.

In one embodiment, the stair case 140 is removed from the frame 110 with the chain hoist 130 being electrically operable. Operation of the snow plow system 100 may be independent of the stair case 140.

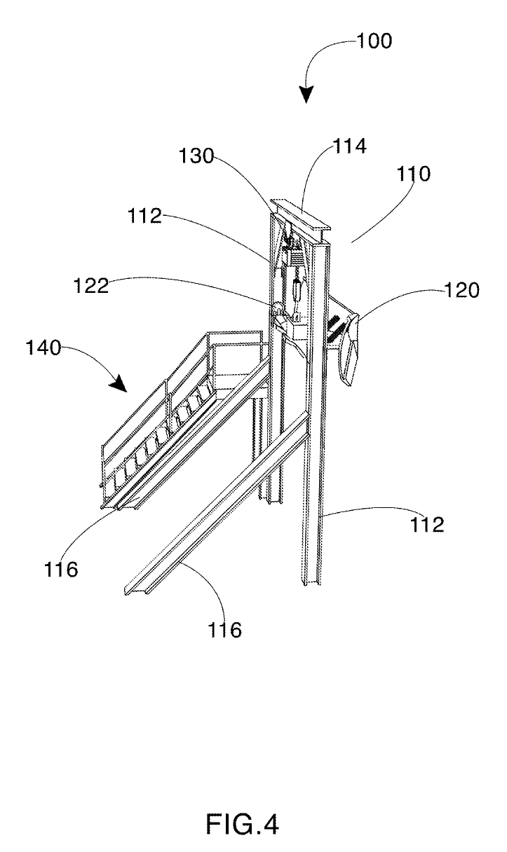

Referring now to FIG. 4, a perspective side view of the snow plow system 100 of FIG. 1, according to an embodiment of the present disclosure. As above, the snow plow system 100 may include the frame 110 having the two vertical support beams 112 connected via the upper horizontal crossbar 114, and the first pair of stabilizers 116 each attached between the two vertical support beams 112 and the ground surface 20. The snow plow 120 may be connected to the frame 110 below the upper horizontal crossbar 114 and movable along the two vertical support beams 112. The chain hoist 130 coupled to the upper horizontal crossbar 114 at one end and to the snow plow 120 at the opposing end may enable the snow plow 120 to be movable along the two vertical support beams 112.

The snow plow 120 may be comprised of steel or other suitable material having sufficient durability for snow 5 removal and winter weather conditions. In one embodiment, the snow plow 120 may be configured in a V-shape for maximum snow 5 removal.

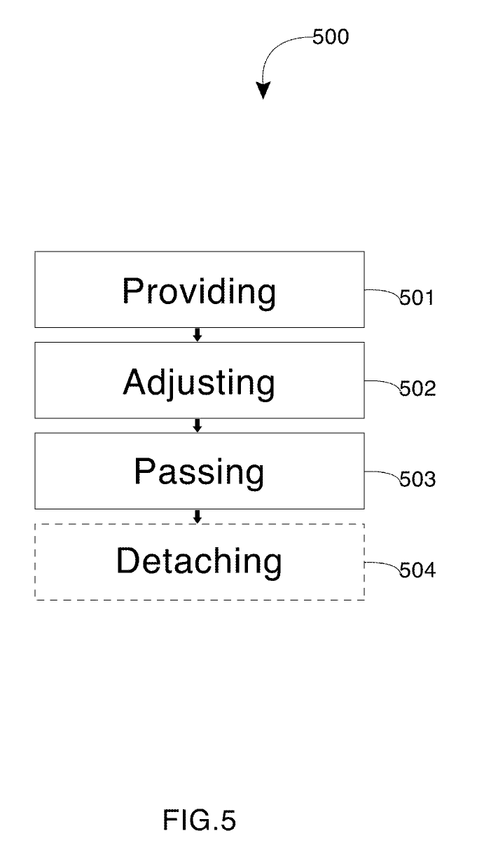

FIG. 5 is a flow diagram illustrating a method for using the snow plow system 500, according to an embodiment of the present disclosure. In particular, the method for using the snow plow system 500 may include one or more components or features of the snow plow system 100 as described above. As illustrated, the method for using the snow plow system 500 may include the steps of: step one 501, providing a snow plow system 100 including a frame 110 having two vertical support beams 112 connected via an upper horizontal crossbar 114, and a first pair of stabilizers 116 each attached between the two vertical support beams 112 and a ground surface 20; a snow plow 120 connected to the frame 110 below the upper horizontal crossbar 114 and movable along the two vertical support beams 112; a chain hoist 130 coupled to the upper horizontal crossbar 114 at one end and to the snow plow 120 at an opposing end; and a stair case 140 removably attachable to the frame 110, the stair case 140 including a series of steps 142; step two 502, adjusting a height of the snow plow 120 to accommodate to a height associated to a roof 10 of a vehicle 15; step three 503, passing the vehicle 15 through the two vertical support beams 112 enabling the snow plow 120 to remove snow 5 from the roof 10 of the vehicle 15; step four 504, detaching the stair case 140 away from the frame 110 such that the snow plow system 100 is utilized without the stair case 140.

It should be noted that step four 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for of snow 5 removal (NOTE: e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A snow plow system for the removal of snow from a roof of a movable vehicle, the snow plow system comprising:
a frame having two vertical support beams connected via an upper horizontal crossbar, and a first pair of stabilizers each attached between the two vertical support beams and a ground surface;
a snow plow connected to the frame below the upper horizontal crossbar and movable along the two vertical support beams;
a chain hoist coupled to the upper horizontal crossbar at one end and to the snow plow at an opposing end; and
a stair case removably attachable to the frame, the stair case including a series of steps;
wherein a vehicle is configured to pass between the two vertical support beams; and
wherein the snow plow is vertically adjustable to a height associated to a roof of the vehicle to enable removal of snow therefrom when the vehicle passes though the two vertical support beams.

2. The snow plow system of claim 1, wherein the chain hoist is manually operable.

3. The snow plow system of claim 2, wherein the stair case includes a height for assisting in manual operation of the chain hoist.

4. The snow plow system of claim 3, wherein the stair case includes a platform at a top of the series of steps configured to support a weight of a user.

5. The snow plow system of claim 4, wherein the platform is supported by at least one vertical-stair-beam.

6. The snow plow system of claim 5, wherein the stair case further includes at least one hand-rail positioned and attached along the series of steps and the platform.

7. The snow plow system of claim 6, wherein the stair case is removably attached to one of the first pair of stabilizers via fasteners.

8. The snow plow system of claim 1, wherein the chain hoist is electrically operable.

9. The snow plow system of claim 8, wherein a remote control is in electrical communication with the chain hoist to provide vertical adjustments to the snow plow, as desired.

10. The snow plow system of claim 1, wherein the frame includes a second pair of stabilizers attached between the two vertical support beams and the upper horizontal crossbar to prevent distortion of the frame.

11. The snow plow system of claim 10, wherein fasteners are included for connecting the two vertical support beams to the upper horizontal crossbar, and the first pair of stabilizers to the two vertical support beams.

12. The snow plow system of claim 10, wherein the two vertical support beams include an I-shaped cross-section.

13. The snow plow system of claim 12, wherein an idler-bearing is positioned within the two vertical support beams and configured to guide the snow plow along a length of the two vertical support beams.

14. The snow plow system of claim 1, wherein snow plow is comprised of steel.

15. The snow plow system of claim 1, wherein the snow plow is configured in a V-shape.

16. The snow plow system of claim 1, wherein the chain hoist is positioned in a middle of the upper horizontal crossbar.

17. A snow plow system comprising:
a frame having two vertical support beams connected via an upper horizontal crossbar, and a first pair of stabilizers each attached between the two vertical support beams and a ground surface;
a snow plow connected to the frame below the upper horizontal crossbar and movable along the two vertical support beams;
a chain hoist coupled to the upper horizontal crossbar at one end and to the snow plow at an opposing end;
a stair case removably attachable to the frame, the stair case including a series of steps;
wherein a vehicle is configured to pass between the two vertical support beams;
wherein the snow plow is vertically adjustable to a height associated to a roof of the vehicle to enable removal of snow therefrom when the vehicle passes though the two vertical support beams;
wherein the chain hoist is manually operable;
wherein the stair case includes a height for assisting in manual operation of the chain hoist;
wherein the stair case includes a platform at a top of the series of steps configured to support a weight of a user;
wherein the platform is supported by at least one vertical-stair-beam;
wherein the stair case further includes at least one hand-rail positioned and attached along the series of steps and the platform;
wherein the stair case is removably attached to one of the first pair of stabilizers via fasteners;
wherein the frame includes a second pair of stabilizers attached between the two vertical support beams and the upper horizontal crossbar to prevent distortion of the frame;
wherein fasteners are included for connecting the two vertical support beams to the upper horizontal crossbar, and the first pair of stabilizers to the two vertical support beams;
wherein the two vertical support beams include an I-shaped cross-section;
wherein an idler-bearing is positioned within the two vertical support beams and configured to guide the snow plow along a length of the two vertical support beams;
wherein snow plow is comprised of steel;
wherein the snow plow is configured in a V-shape; and
wherein the chain hoist is positioned in a middle of the upper horizontal crossbar.

18. The snow plow system of claim 17, further comprising set of instructions; and
wherein the snow plow system is arranged as a kit.

19. A method of using a snow plow system, the method comprising the steps of:
providing a snow plow system including a frame having two vertical support beams connected via an upper horizontal crossbar and a first pair of stabilizers each attached between the two vertical support beams and a ground surface; a snow plow connected to the frame below the upper horizontal crossbar and movable along the two vertical support beams; a chain hoist coupled to the upper horizontal crossbar at one end and to the snow plow at an opposing end; and a stair case removably attachable to the frame, the stair case including a series of steps;
adjusting a height of the snow plow to accommodate to a height associated to a roof of a vehicle; and
passing the vehicle through the two vertical support beams enabling the snow plow to remove snow from the roof of the vehicle.

20. The method of claim 19, further comprising the step of detaching the stair case away from the frame such that the snow plow system is utilized without the stair case.
